(19) United States
(12) Patent Application Publication
(10) Pub. No.: US 2011/0085948 A1
(43) Pub. Date: Apr. 14, 2011

(54) DEVICES AND METHODS FOR COLLECTING AND PROCESSING A SPECIMEN

(76) Inventors: Val L. Poll, Ogden, UT (US); Steven J. Miller, Hyrum, UT (US); Jay J. Davis, Smithfield, UT (US); Brian T. Leishman, Wellsville, UT (US); Joshua L. Kirk, Providence, UT (US)

(21) Appl. No.: 12/577,560

(22) Filed: Oct. 12, 2009

(51) Int. Cl. B01L 3/00

(52) U.S. Cl. 422/409; 422/534

(57) ABSTRACT

Embodiments of the present invention include a specimen collection assembly that limits or eliminates the need for transferring a specimen sample from one container to another. The specimen collection assembly includes a fecal loop, a filter and a lid each to be employed with a vile. The filter is attachable to a distal portion of the fecal loop. The lid is configured to be positioned over the open end of the vile with both the fecal loop and filter positioned in the vile. With this arrangement, a liquid solution can be introduced into the vile and then agitated to mix with a specimen sample. The fecal loop with the attached filter can then be withdrawn from the vile to leave the remaining filtered and mixed liquid solution in the vile.

### TECHNICAL FIELD

The present invention relates generally to a device, assembly and method employed in the collection and analysis of specimens and, more specifically, the collection and analysis of fecal matter or other biological matter.

### BACKGROUND

Various methods and devices have been used in the past for collecting, transporting and then testing biomedical samples. Many of the biomedical samples are fecal samples taken by veterinarians or technicians at veterinary clinics. The standard practice for taking a fecal sample involves transferring the sample from one container to another typically several times. For example, after extracting a sample from a mammalian, such as with a fecal loop, the veterinarian will then empty the sample from the fecal loop into a container or place the fecal loop with the sample in the container. Such container is then transported to a laboratory for testing. Once the laboratory receives the shipment, the sample is then placed into a mixing container, in which the sample is mixed with a liquid solution. The liquid solution is then strained or filtered into another container or vile for conducting testing on the filtered solution. As such, from the field to obtaining results from laboratory testing, the sample is typically transferred into different containers several times. Such transferring of the sample is tedious, messy, inefficient and costly, especially when compounding this process with high sample volumes being received at laboratories conducting the sample testing. Further, each time the sample is transferred from one container to another there is an increased risk of compromising the sample and/or contamination from outside sources. Unfortunately, the high volume of samples being tested in laboratories even further compounds the risk of compromising the sample specimens.

Based on the foregoing reasons, it would be advantageous to provide a sample collection assembly that limits or, even eliminates, the risk of compromising or contamination of a specimen sample due to transferring such specimen sample from one container to another. Further, it would be advantageous to provide a sample collection assembly that is less tedious and messy and improves efficiency for the laboratory technician and, therefore, saves time and is less costly.

### BRIEF SUMMARY OF THE INVENTION

Embodiments of the present invention include a specimen collection assembly that limits or eliminates the need for transferring a specimen sample from one container to another from the collection process to the testing of the specimen in the laboratory. Embodiments of the present invention further include related methods and systems.

In accordance with one embodiment of the present invention, a fecal specimen collection assembly is provided. The fecal specimen collection assembly includes a container member, a fecal loop, a filter and a lid. The container member includes an open end and a closed end. The fecal loop includes a handle and a loop portion. The loop portion extends from one end of the handle. Further, the loop portion includes a loop attachment portion at a distal end of the loop portion. The filter includes a filter attachment portion, which is configured to reversibly attach to the loop attachment portion at the distal end of the fecal loop. The lid is configured to be positioned over the open end of the container member with both the fecal loop and filter positioned in the container member.

In another embodiment, the loop attachment portion includes an extension nub that is configured to be attached to the filter attachment portion. The filter attachment portion includes an opening defined in the filter such that the opening is configured to receive the extension nub with a snap-type fit.

In another embodiment, the filter includes a central portion and a plurality of tabs. The plurality of tabs extend from the central portion in a spoke-type configuration. The plurality of tabs are deflectable at a location adjacent the central portion such that the tabs are configured to be moved to a confined filter configuration when positioned in the container member. Further, the plurality of tabs define at least one aperture extending therethrough.

In another embodiment, the lid includes a lid head and a lid extension. The lid head is configured to be positioned over the open end of the container member. The lid extension includes a hollow portion defined therein such that the hollow portion is configured to receive a portion of the handle of the fecal loop. Further, the lid includes an opening defined therein such that the opening extends through the lid and corresponds with the hollow portion of the lid extension.

In still another embodiment, the fecal loop includes one or more channels defined in a proximal portion of the handle such that the one or more channels extend longitudinally toward the loop portion. In another embodiment, the proximal portion of the handle with the one or more channels defined therein is configured to be disposed at least partially within the hollow portion of the lid extension such that the one or more channels are configured to facilitate solution to be received in the container member through the opening of the lid.

In accordance with another embodiment of the present invention, a specimen collection assembly configured to be used with a container member is provided. The specimen collection assembly includes a specimen collection member, a filter and a lid. The specimen collection member includes a handle portion and a specimen collection portion. The specimen collection portion extends from one end of the handle portion. The filter is configured to be attachable to the specimen collection member, wherein, in an attached state, the filter is configured to be inserted into the container member with the specimen collection member such that at least a portion of the filter is distal of the specimen collection portion. The lid is configured to be positioned over an open end of the container member.

In another embodiment, the specimen collection member includes an extension nub that is configured to be attachable to the filter. In still another embodiment, the extension nub extends from a distal end of the specimen collection portion. Such an extension nub is configured to be reversibly attachable to the filter.

In another embodiment, the filter includes a central portion and multiple filter tabs. The multiple filter tabs extend from the central portion and are movable between an expanded, non-use state, and a confined, use state, when positioned in the container member. The central portion includes a filter attachment portion that is configured to be attached to the specimen collection member. In another embodiment, the confined, use state, of the filter includes the multiple filter tabs being movable to surround at least a distal portion of the specimen collection portion when positioned in the container member.

In still another embodiment, the handle portion of the specimen collection member includes at least one channel defined in a proximal portion of the handle portion. The at least one channel is configured to facilitate a liquid solution to be collected into the container member. In another embodiment, the lid includes a hole defined therein, the hole being sized and configured to at least partially receive the proximal portion of the handle portion with the at least one channel such that the liquid solution can be inserted into the hole and pass through the at least one channel defined in the handle portion and collect into the container member.

In still another embodiment of the present invention, a fecal specimen collection assembly configured to be used with a vile, is provided. The fecal specimen collection assembly includes a fecal capturing member and a filter. The fecal capturing member includes a handle and a fecal capturing portion that extends from one end of the handle. The filter is configured to be attachable to the fecal capturing member such that at least a portion of the filter surrounds a distal portion of the fecal capturing portion of the fecal capturing member.

In another embodiment, the filter is configured to be attached to a distal end of the fecal capturing portion of the fecal capturing member. In still another embodiment, the fecal capturing portion includes an extension nub that extends from a distal end of the capturing portion, and the filter includes an aperture defined therein. The extension nub is sized and configured to be inserted into the aperture with a snap-type fit for reversible attachment between the fecal capturing member and the filter.

In accordance with another embodiment of the present invention, a method for processing a specimen with a vile utilized to capture the specimen is provided. The method includes: receiving a specimen captured within a specimen collection assembly, the specimen collection assembly including a specimen capturing member and a filter, the filter attached to a distal end of the specimen capturing member, and the filter and the specimen capturing member positioned within the vile; introducing a liquid solution in the vile with the specimen capturing member and filter; agitating the liquid solution with the specimen with the filter and specimen capturing member in the vile; filtering the specimen from the liquid solution by withdrawing the specimen capturing member and the filter from the vile; and processing the filtered liquid solution remaining in the vile.

In another embodiment, the introducing includes introducing the liquid solution through an opening in a lid of the specimen collection assembly. In still another embodiment, the introducing includes introducing the liquid solution through an opening in a lid that flows through a channel defined in a handle of the specimen capturing member. In still another embodiment, the filtering includes removing the lid, the specimen capturing member and filter from the vile.

These and other aspects of the present invention will become more fully apparent from the following description and appended claims, or may be learned by the practice of the invention as set forth hereinafter.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is an exploded view of a fecal specimen collection assembly, illustrating a fecal loop and a filter configured to be placed within a vile and a lid to cover the vile, according to an embodiment of the present invention;

FIG. 2 is a perspective view of the fecal specimen collection assembly of FIG. 1 in an assembled state, according to the present invention;

FIG. 3A is a cross-sectional view of a distal portion of the fecal specimen collection assembly depicted in FIG. 2, illustrating the fecal loop attached to the filter at a bottom portion of the vile, according to one embodiment of the present invention;

FIG. 3B is a cross-sectional view of a proximal portion of the fecal specimen collection assembly depicted in FIG. 2, illustrating the lid captured over the vile and handle of the fecal loop, according to another embodiment of the present invention;

FIG. 4 is a front view of the filter in a non-deflected position, according to another embodiment of the present invention;

FIG. 4A is a cross-sectional view of the filter taken along line 4A of FIG. 4, depicting the filter being moveable to a deflected position, according to another embodiment of the present invention;

FIG. 5 is a perspective view of the filter attached to a distal end of the fecal loop, the filter in a non-deflected position, according to another embodiment of the present invention;

FIG. 5A is a front view of the filter attached to a distal end of the fecal loop, depicting the filter within the vile (shown in outline), according to another embodiment of the present invention;

FIG. 6 is a perspective view of a proximal portion of the handle of the fecal loop, depicting channels formed in the proximal portion, according to another embodiment of the present invention; and

FIG. 7 is a perspective view of a portion of the proximal portion of the handle captured within the lid, depicting a portion of a channel defined in the handle exposed with respect to the lid, according to another embodiment of the present invention.

### DETAILED DESCRIPTION OF THE INVENTION

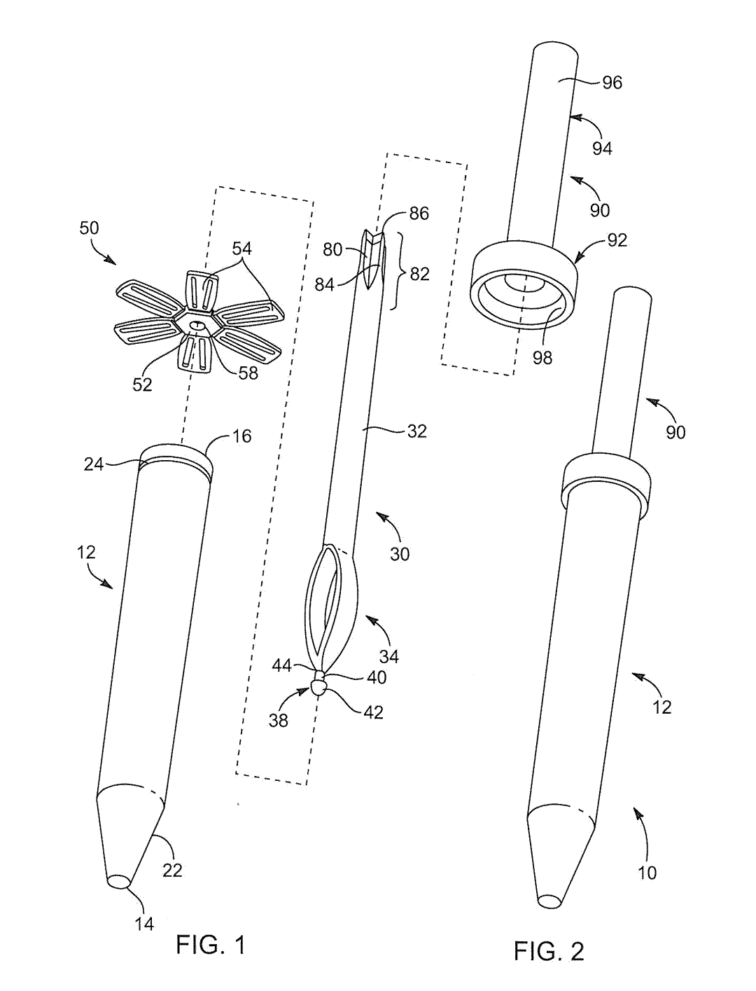

Referring to FIGS. 1 and 2, a specimen collection assembly 10 is shown, in exploded form and assembled, respectively. The specimen collection assembly 10 of the present invention is employed to minimize the steps and cost in the collection and processing of specimen samples, such as fecal matter specimens, in the field and laboratory. The specimen collection assembly 10 also minimizes the risk of compromising and/or contamination of a specimen sample due to transferring such specimen sample from one container to another.

Such a specimen collection assembly 10 can include a specimen collection member 30, a filter 50, and a lid 90, each to be employed with a typical vile 12 for containing the assembly and specimen. In particular, the specimen collection member 30 is employed first to obtain a specimen, such as a fecal specimen, or any other suitable specimen for sampling. The specimen collection member 30 may then be attached to the filter 50. The specimen collection member 30 and attached filter 50 may then be inserted into the vile 12, after which, the lid 90 may then be placed over the vile 12 for retaining the assembled filter 50 and collection member 30, and specimen therein. The specimen with the specimen collection assembly 10 can then be transported to the laboratory for processing and testing. Once received, a laboratory technician can insert a solution into the vile 12 without removing the lid 90. The solution is then agitated or mixed with the specimen, after which, the specimen collection assembly 10 is removed from the vile 12. When removing the lid 90, the specimen collection member 30 and filter 50 are also removed such that the filter removes the larger matter from the specimen, leaving the filtered solution in the vile 12 for the laboratory technician to conduct further tests. With this arrangement, the specimen collection assembly of the present invention provides a method by which a single container may be used in the field and laboratory to perform laboratory tests on a specimen sample to, thereby, limit the risk of contamination of the sample and obtaining compromised or inaccurate test results. Further embodiments and structural details of the specimen collection assembly of the present invention will now be discussed.

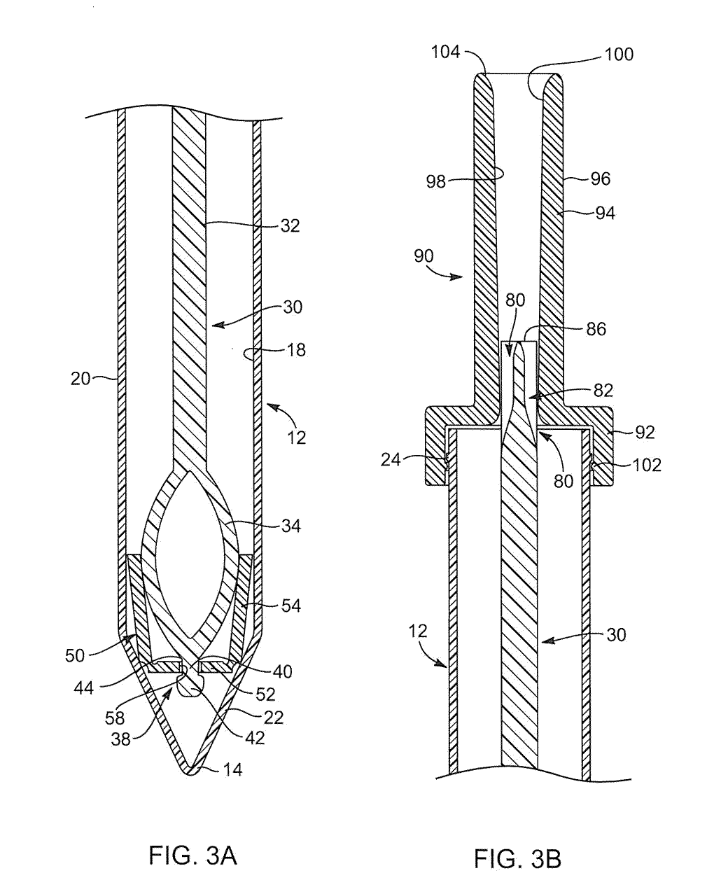

With reference to FIGS. 1 and 3A, the vile 12 or container member can typically include a hollow cylindrical shape or tubular member with a closed end 14 and an open end 16. The vile 12 includes an inner surface 18 and an outer surface 20 that may include a taper 22 adjacent the closed end 14 in a conical type shape. The outer surface 20 may include a protrusion 24 in the form of a ring extending adjacently around the open end 16. Such a protrusion 24 can assist in retaining the lid 90 to the proximal open end 16 of the vile 12.

The specimen collection member 30 can include a handle 32 and a specimen collection portion or, for example, a loop portion 34 that extends from one end of the handle 32. The specimen collection member 30 is configured to collect various types of specimens that may include fecal matter, or any other type of matter needed for testing. The specimen collection member 30 may include the basic features of a typical fecal loop, however, the specimen collection member 30 is not limited to a fecal loop. Such specimen collection member 30 may include other structures, such as a swab, or any other structure suitable for taking a specimen sample.

As set forth, the specimen collection portion can be in the form, and include the profile, of an oval loop or loop portion 34 extending from one end of the handle 32. Such a handle 32 and loop portion 34 may be sized and configured to readily allow a person to grasp the handle 32 and take, for example, a fecal sample from a mammalian body, with the loop portion 34. Although the specimen collection portion is shown as a loop structure, other suitable structures may be employed that readily capture fecal matter and substantially retain such fecal matter therewith. According to the present invention, in addition to the loop portion 34 and the handle 32, the specimen collection member 30 can include additional structural features designed to stream-line the collection and processing of a specimen.

With respect to FIGS. 1, 3A and 5, according to one embodiment, the specimen collection member 30 can include an attachment portion that is sized and configured to attach to the filter 50 such that the filter 50 is reversibly attached and at least a portion is positioned distal or surrounds a distal portion of the loop portion 34 of the specimen collection member 30. In one embodiment, the attachment portion of the specimen collection member 30 can be an extension nub 38. Such an extension nub 38 can include a neck 40 and a head 43 that can extend distally from a distal end 44 of the loop portion 34. The extension nub 38 can be sized and configured to be attached to the filter 50 with a snap-type fit or an interference type fit. In another embodiment, the extension nub 38 may include threads to be threadably attached to the filter or, any other suitable structure for attaching the specimen collection member 30 to the filter 50.

Now referring to FIGS. 1, 3A, 4 and 5, the filter 50 can include a central portion 52 and multiple filter tabs 54 extending from the central portion 52. As previously set forth, the filter 50 can include a filter attachment portion. In one embodiment, the filter attachment portion can include an aperture 58 or through hole defined in the central portion 52 of the filter 50 that is sized and configured to receive the extension nub 38 therein. The head 42 of the extension nub 38 can be manually forced through the aperture 58 with a snap-type fit or interference fit so that the distal end 44 of the loop portion 34 seats against a surface of the central portion 52 with the neck 40 positioned within the aperture 58 and the head 42 positioned therethrough.

In another embodiment, the filter attachment portion may be a recess sized and configured to receive the extension nub, or any other suitable structure for receiving the extension nub to attach the filter 50 to the specimen collection member 30. In another embodiment, the filter attachment portion may include an extension structure, or any other suitable structure, that is sized and configured to attach to a recess or capturing portion defined in the specimen collection member 30.

With respect to FIGS. 3A, 4, 4A and 5, as previously indicated, the filter 50 can include multiple filter tabs 54 or multiple filter portions that extend from the central portion 52. Further, the filter 50 includes a first side 60 and a second side 62 that define a periphery 64 or edge between the first side 60 and second side 62. The structure of the first side 60 and second side 62 may be formed to be substantially similar. As earlier indicated, the central portion 52 may include the aperture 58 or filter attachment portion, which may be positioned centrally within such central portion 52. The filter tabs 54 can extend radially from the central portion 52 to, collectively provide, a spoke-like configuration. For example, the central portion 52 can include a hexagonal configuration or six sides each with a filter tab 54 extending therefrom. The central portion 52 may include any other suitable shaped configuration, such as octagonal, square or round. Each filter tab 54 can include one or more openings 66 defined therein that extend through the tab 54 and may be sized and configured to facilitate a filtering function of the specimen. The openings 66 in the tab 54 can define an elongated shape with a width 68, or any other shape or configuration, to provide desired filtering characteristics.

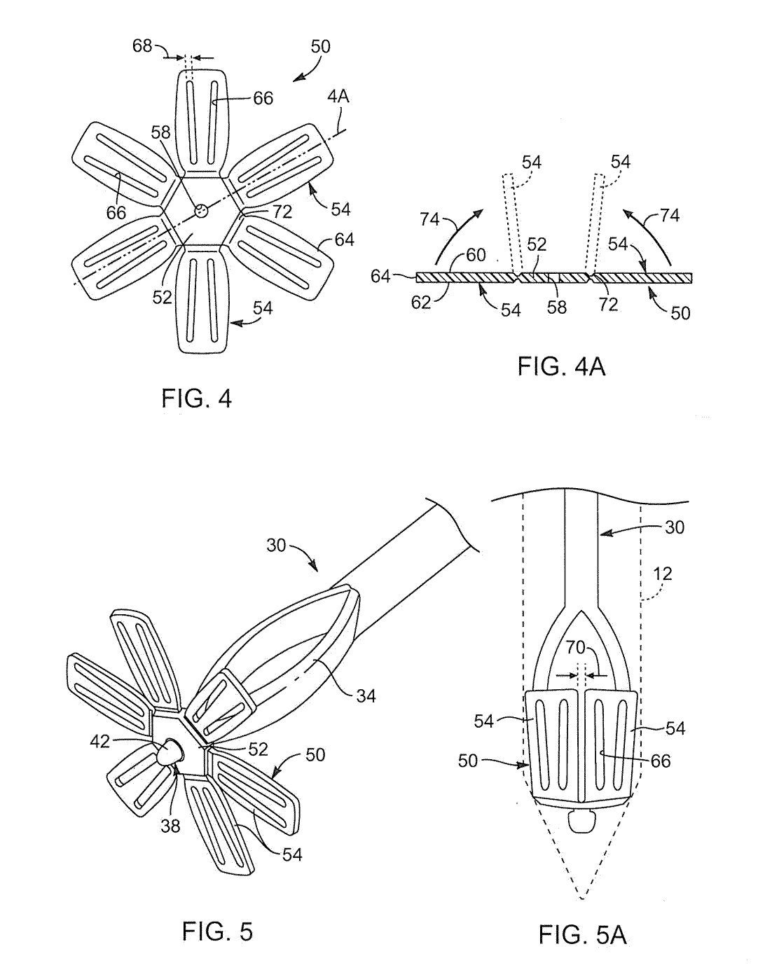

Further, with respect to FIGS. 4 and 5A, the filter tabs 54, when in a deflected configuration positioned in the vile 12 (shown in outline), may be spaced a distance 70 similar to the width 68 of the openings 66, such that the spaced distance 70 of the filter tabs 54 also provide a filtering function, similar to the openings 66 defined in the filter tabs 54. As shown in FIG. 4, the side walls or periphery 64 of each filter tab 54 may be slightly curved so that when placed in the vile 12 the spaced distance 70 is substantially consistent along a length of each filter tab 54, as shown in FIG. 5A. The width 68 of the openings 66 and the spaced distance 70 of two adjacent tabs may be about 0.0200 inches to 0.0400 inches and preferably about 0.0250 inches to 0.0350 inches. In this manner, both the openings 66 in the tabs 54 and the spaced distance 70 between the tabs 54 in the deflected configuration may provide the filtering function of the filter 50. In another embodiment, the filter tabs 54 or filter portion may also include a screen member or portions of a screen configuration.

As previously set forth, the multiple filter tabs 54 can be positioned in an expanded configuration or orientation or non-use state (depicted in FIGS. 4 and 5), and can also be positioned in a deflected configuration or orientation or a narrow confined, use state (depicted in FIGS. 3A and 5A). The filter 50 can be employed to readily deflect by forming the interconnection between the tabs 54 and the central portion 52 with a thinned wall structure 72. Deflection of the tabs 54 from the expanded configuration, deflecting relative to the central portion 52 or thinned wall structure 72, is shown with arrows 74 in FIG. 4A. With this arrangement, the thinned wall structure 72 provides a living hinge between the tabs 54 and the central portion 52 that may readily allow the tabs 54 to deflect to a deflected or narrow configuration when placing or, rather, inserting the filter 50 into the vile 12 while attached to the specimen collection member 30. Further, due to the first side 60 and second side 62 of the filter 50 being substantially similar, the filter 50 can be attached to the specimen collection member 30 at either the first side 60 or the second side 62 of the filter 50.

In another embodiment, the filter 50 can be preformed into the narrow configuration or use state (similar to that shown in FIG. 5A) such that the filter tabs 54 or filter portion is interconnected and do not deflect in the manner previously set forth. With this arrangement, the filter 50 may include a cup-like configuration with the central portion at a bottom wall of the cup-like configuration and side walls being the filter portion. As such, the extension nub can reversibly attach, for example, to the bottom wall of the filter such that the sidewall or filter portion surrounds at least a distal portion of the loop portion of the specimen collection member, as depicted in FIG. 5A.

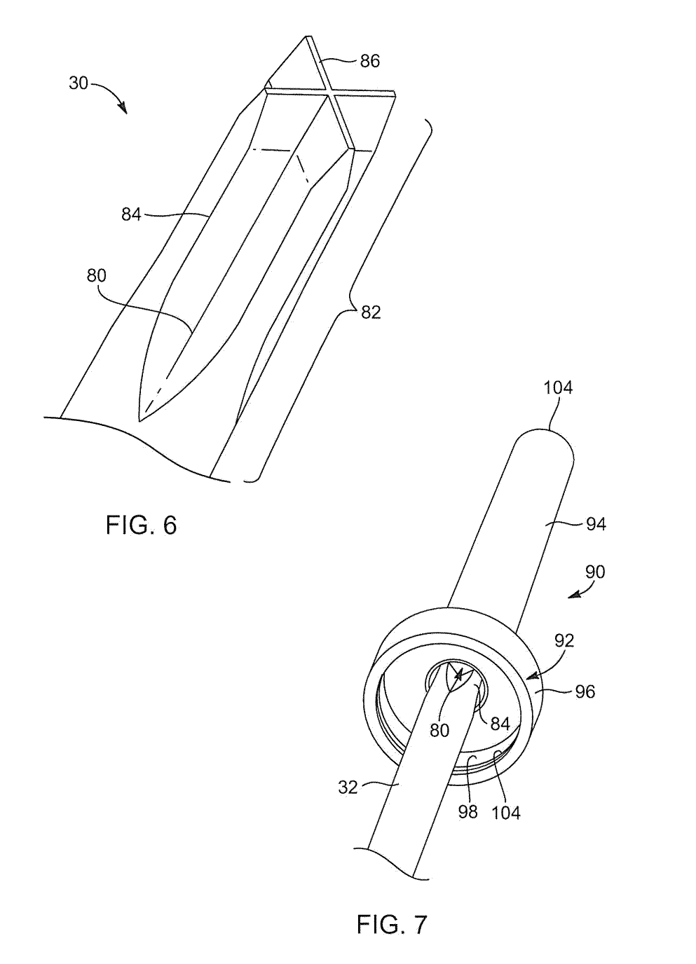

Referring now to FIGS. 1, 3B and 6, in one embodiment, the specimen collection member 30 may also include one or more channels 80 defined in a proximal portion 82 of the handle 32 of the specimen collection member 30. Such one or more channels 80 are sized and configured to facilitate a liquid solution (not shown), employed during a testing procedure, to flow through the channels 80 when the specimen collection member 30 is captured in the vile 12 with the lid 90 positioned over the vile 12. The one or more channels 80 can extend and be defined in the handle 32 with a ravine-like structure or any other suitable structure, such as a tunnel, or any other type of passageway that will facilitate the liquid solution to pass therethrough. In one embodiment, the one or more channels 80 can include a plurality of channels, such as four channels. Each channel 80 can be defined by a ridge 84 extending along both sides of each channel 80. The channels 80 can extend along a longitudinal length of the handle 32 from a proximal end 86 and along the proximal portion 82 of the handle 32 or partially along the length of the handle 32.

Now referring to FIGS. 1, 3B and 7, in one embodiment, the lid 90 may include a lid head 92 and a lid extension 94. The lid head 92 is sized and configured to be captured over the open end 16 of the vile 12. The lid extension 94 is sized and configured to at least partially capture the proximal portion 82 of the handle 32 of the specimen collection member 30. The lid head 92 and the lid extension 94 can each include an outer surface 96 and an inner surface 98 such that the inner surface 98 defines a hollow portion 100 extending through the length of the lid extension 94 and extending between a proximal opening 104 and a distal opening 106 to define a through hole in the lid 90. The distal opening 106 is defined in and exposed in the inner surface 98 of the lid head 92 and the proximal opening 104 is defined and exposed at a tip end 108 of the lid extension 94. The inner surface 98 of the lid head 92 can include a ridge 102 sized and configured to fit over the ring protrusion 24 of the vile 12 to assist maintaining the lid 90 with the vile 12. Further, the distal opening 106 and hollow portion 100 defined in the lid extension 94 may be sized and configured to fit, in a snug manner, with at least a portion of the proximal portion 82 of the handle 32 such that the ridges 84 at the proximal portion 82 engage or are in direct contact with the inner surface 98 of the lid extension 94.

As depicted in FIGS. 3B and 7, with the lid extension 94 sized and configured to at least partially receive the proximal portion 82 of the handle 32, a portion of the one or more channels 80 are exposed to, thereby, allow liquid solution to pass therethrough. With this arrangement, solution can be passed through the proximal opening 100 at the tip end 108 of the lid 90, in which the solution passes through the hollow portion 100 of the lid 90 and along the channels 80 and into the vile 12 without having to remove the lid 90.

Referring again to FIG. 1, the vile 12, specimen collection member 30, filter 50 and lid 90 can be formed from polymeric materials or thermo plastics, such as Polypropylene (PP), High Density Polyethylene (HDPE), Low Density Polyethylene (LDPE), or any other suitable material known to those of ordinary skill in the art. Further, such can be formed and manufactured utilizing manufacturing techniques known in the art, such as injection molding, thermo forming, plastic stamping, or machining, or any other suitable technique known in the art.

In use, the specimen collection assembly 10 of the present invention substantially reduces the risk of cross-contamination or compromising the specimen sample to be tested by limiting the need to transfer the specimen from one container to another in the field and while processing of the specimen sample. Specifically, in one embodiment, a technician, such as a veterinarian, takes a fecal sample, utilizing the specimen collection member 30. Once the technician obtains a suitable fecal sample, captured within the loop portion 34 of the specimen collection member 30, the technician then attaches the specimen collection member 30 to the filter 50. This attachment may be employed by manually inserting the extension nub 38 into the aperture 58 defined in the central portion 52 of the filter 50 until the extension nub 38 snaps into an attached position, as depicted in FIG. 5. At this stage, the filter 50 is in an expanded orientation. The technician may then insert the filter 50 and specimen collection member 30 into the vile, first inserting the bottom side of the filter 50, to thereby fold or deflect the filter tabs 54 into a deflected orientation, as depicted in FIGS. 3A and 5A. Once the filter 50 is positioned adjacent the closed end 14 within the vile 12 with the specimen collection member 30 attached thereto, a portion of the proximal portion 82 of the handle 32 of the specimen collection member 30 may be positioned to extend above the open end 16 of the vile 16, as depicted in FIGS. 3A and 3B. The lid 90 may then be captured or placed over the open end 16 of the vile. Such capturing may include at least a portion of the proximal portion 82 of the vile 12 being captured in the lid extension 94 of the lid 90 such that a portion of the channels 80 defined in the proximal portion 82 are exposed with respect to the lid extension 94, as depicted in FIGS. 3B and 7. At this stage, the specimen collection assembly 10 is assembled, as depicted in FIG. 2, and may then be transported to the laboratory for testing. Once a lab technician receives the specimen collection assembly 10, the lab technician may prepare to mix a liquid solution (not shown) with the fecal sample within the vile 12. Such can be employed without removing the lid 90 by inserting the liquid solution through the proximal opening 104 at the tip end 108 of the lid 90 (see FIG. 3B). The liquid solution enters the vile 12 through such opening 104 and along the channels 80 formed in the proximal portion 82 of the handle 32. Once the lab technician has filled the vile 12 with the required amount of liquid solution, the liquid solution is mixed with the fecal sample by shaking or agitating the vile 12. After agitation of the vile 12, the lid 90 is removed along with the specimen collection member 30 and attached filter 50. The position of the filter 50 is at least partially on a distal side or distal end 44 of the loop portion 34 bearing the fecal sample such that the filter 50 at least partially surrounds a distal portion of the loop portion 34, as depicted in FIGS. 3A and 5A. As such, when the filter 50 and specimen collection member 30 are removed, the filtered liquid solution (that has been mixed with the fecal matter) is left remaining in the vile 12. The filter 50 and attached specimen collection member 30 and lid 90 may then be properly discarded. The lab technician can then simply analyze the filtered solution left in the vile 12, the vile 12 being the original vile 12 utilized when taking the specimen sample. In this manner, the specimen collection assembly 10 of the present invention stream-lines the testing process of specimen samples by facilitating the use of a single vile 12 from collecting the specimen in the field through the processing and testing procedure to, thereby, limit risk associated with contamination and compromise of the specimen sample.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A fecal specimen collection assembly, comprising:
a container member defining an open end and a closed end;
a fecal loop including a handle and a loop portion, the loop portion extending from one end of the handle and the loop portion including a loop attachment portion at a distal end of the loop portion;
a filter having a filter attachment portion, the filter attachment portion being configured to reversibly attach to the loop attachment portion at the distal end of the fecal loop; and
a lid configured to be positioned over the open end of the container member with the filter and fecal loop positioned in the container member.

2. The fecal specimen collection assembly of claim 1, wherein the loop attachment portion comprises an extension nub configured to be attachable to the filter attachment portion.

3. The fecal specimen collection assembly of claim 2, wherein the filter attachment portion comprises an opening defined in the filter, the opening configured to receive the extension nub with a snap-type fit.

4. The fecal specimen collection assembly of claim 1, wherein the filter comprises a central portion and a plurality of tabs extending from the central portion in a spoke-type configuration.

5. The fecal specimen collection assembly of claim 4, wherein the plurality of tabs are deflectable from a location adjacent the central portion such that the wings are configured to be moved to a confined filter configuration when positioned in the container member.

6. The fecal specimen collection assembly of claim 4, wherein the plurality of tabs define at least one aperture extending therethrough.

7. The fecal specimen collection assembly of claim 1, wherein the fecal loop comprises one or more channels defined in a proximal portion of the handle, the one or more channels extending longitudinally toward the loop portion.

8. The fecal specimen collection assembly of claim 1, wherein the lid comprises a lid head and a lid extension, the lid head configured to be positioned over the open end of the container member, the lid extension including a hollow portion defined therein, the hollow portion configured to receive a portion of the handle of the fecal loop.

9. The fecal specimen collection assembly of claim 8, wherein the lid comprises an opening defined in the lid, the opening extending through the lid and corresponding with the hollow portion of the lid extension.

10. The fecal specimen collection assembly of claim 9, wherein the fecal loop comprises one or more channels defined in a proximal portion of the handle, the one or more channels extending longitudinally toward the loop portion and configured to be disposed at least partially within the hollow portion of the lid extension, the one or more channels configured to facilitate solution to be received in the container member through the opening of the lid.

11. A specimen collection assembly configured to be used with a container member, comprising:
a specimen collection member including a handle portion and a specimen collection portion, the specimen collection portion extending from one end of the handle portion;
a filter configured to be attachable to the specimen collection member, wherein, in an attached state, the filter is configured to be inserted into the container member with the specimen collection member such that at least a portion of the filter is distal of the specimen collection portion; and
a lid configured to be positioned over an open end of the container member.

12. The specimen collection assembly of claim 11, wherein the specimen collection member comprises an extension nub configured to be attachable to the filter.

13. The specimen collection assembly of claim 12, wherein the extension nub extends from a distal end of the specimen collection portion, the extension nub configured to be reversibly attachable to the filter.

14. The specimen collection assembly of claim 11, wherein the filter comprises a central portion and multiple filter tabs, the multiple filter tabs extending from the central portion and movable between an expanded, non-use state, and a confined, use state, when positioned in the container member, the central portion including a filter attachment portion configured to be attached to the specimen collection member.

15. The specimen collection assembly of claim 11, wherein the confined, use state, of the filter comprises the multiple filter tabs being movable to surround at least a distal portion of the specimen collection portion when positioned in the container member.

16. The specimen collection assembly of claim 11, wherein the handle portion comprises at least one channel defined in a proximal portion of the handle portion, the at least one channel configured to facilitate a liquid solution to be collected into the container member.

17. The specimen collection assembly of claim 16, wherein the lid comprises a hole defined therein, the hole sized and configured to at least partially receive the proximal portion of the handle portion with the at least one channel such that the liquid solution can be inserted into the hole and pass through the at least one channel defined in the handle portion and collect into the container member.

18. A fecal specimen collection assembly configured to be used with a vile, comprising:
a fecal capturing member including a handle and a fecal capturing portion, the fecal capturing portion extending from one end of the handle; and
a filter configured to be attachable to the fecal capturing member such that at least a portion of the filter surrounds a distal portion of the fecal capturing portion of the fecal capturing member.

19. The fecal specimen collection assembly of claim 18, wherein the fecal capturing portion comprises an extension nub extending from a distal end of the capturing portion, and the filter comprises an aperture, the extension nub sized and configured to be inserted into the aperture with a snap-type fit for reversible attachment between the fecal capturing member and the filter.

20. The fecal specimen collection assembly of claim 18, wherein the filter is configured to be attached to a distal end of the fecal capturing portion of the fecal capturing member.
